(19) United States
(12) Patent Application Publication
(10) Pub. No.: US 2006/0238360 A1
(43) Pub. Date: Oct. 26, 2006

(54) Reusable waste issue alarm device apparatus for the diaper

(76) Inventor: Geng-Kaung Paul Ho, Richardson, TX (US)

Correspondence Address: Geng-Kaung Paul Ho, 1119 Grassmere Dr., Richardson, TX, 75080, US

(21) Appl. No.: 11/113,723

(22) Filed: Apr. 26, 2005

(51) Int. Cl. G08B 23/00

(52) U.S. Cl. 340/573.5

(57) ABSTRACT

This invention provides a waste issue alarm device to detect and indicate the weight increment of new urine issue or feces issue in the diaper, and transmit a waste issue alarm. The number of the urine or feces issue is counted separately. The waste issue alarm will indicate the count of the urine issue and the feces issue and their weights. An adjustable belt unit with hanger is used to hold the waste issue alarm device and hang it outside the diaper. A remote alarm may also be used. It may also monitor the urine issue and the feces issue of multiple diapers. An emergency alarm may be activated when the carried component of the device is submerged in the water.

### BACKGROUND OF THE INVENTION

This invention is related to alarm devices responsive to the presence of urine or feces in the diaper. Some previous inventions provide urine detecting device to detect the urine issue in the diaper. The urine detecting devices were equipped with the diaper. Once the diaper is thrown away due to wetness, the urine detecting device is also thrown away. Some urine detecting devices may be reusable; they detect the wetness of the diaper and issue the alarm. However the alarm may not indicate the number of times for the urine issue. The alarm does not tell the guardian, who wants to wait until the wearer issues urine a certain number of times before changing the diaper, how many times the wearer has issued urine. And the feces issue of the wearer were not detected nor counted. Some inventions, such as my U.S. Pat. No. 5,790,035, place the detecting device inside the diaper and touch the urine or the feces. The urine or the feces on the detecting device needs to be cleansed for each use. This may discourage the acceptance of the detecting devices. It is therefore necessary to design, for the diaper, a waste issue alarm device which Is reusable, placed outside of the diaper, and able to issue alarm indicating the number of times and the weights of the urine and feces issue.

### SUMMARY OF THE INVENTION

This invention provides a reusable waste issue alarm apparatus for the diaper. The device of the apparatus consists of battery, battery monitor, device tester, weight sensor, weight deviation sensor, weight issue screener, wetness sensor, alarm controller, alarm generator, and adjustable belt unit with hanger. The battery supplies the electric power for the device. The battery monitor monitors the usefulness of the battery and sends signal to indicate a low charge of the battery to the alarm controller. The device tester allows the guardian to test the usefulness of the device. The weight sensor measures the weight from the urine and the feces inside the diaper. The weight deviation sensor detects the weight change. Once it detects the weight change, it will repeatedly in each preset period of time, send the weight change information to waste issue screener. The waste issue screener screens the weight change information to confirm if it is from the urine issue or the feces issue. The waste issue screener also discerns between the urine issue and the feces issue, and detects the increment of the urine issue count or the feces issue count. The waste issue screener then notifies the alarm controller.

Upon receiving the notification from waste issue screener, the alarm controller shall determine a way to express the urine or feces information and notify the alarm generator, which in turn will issue the alarm to remind the guardian to change the diaper. The notification to alarm generator will depend on the urine issue count and the feces issue count. The notification from battery tester to alarm controller will also reset both of the urine issue count and the feces issue count.

The alarm generator may send a modulated alarm to a remote alarm generator and issue an alarm remotely. Also the modulated alarm may include the identification of the carried component of the waste issue alarm device. Thus remote generator may generate the alarm with the identification, and allow a guardian to monitor more than one diaper. When the whole device is submerged in the water, wetness sensor will cause an emergency alarm to be issued.

The adjustable belt unit with hanger is used to hold the device and hang it outside the diaper.

It is therefore a primary object of this invention to provide a reusable waste issue alarm device for the diaper to detect the weight deviation coming from new urine issue and new feces issue.

It is another object of this invention to provide a reusable waste issue alarm device for the diaper to display the number of times for the urine issue and the feces issue and their weights, and to issue the alarm accordingly.

It is another object of this invention to provide a reusable waste issue alarm device for the diaper to issue remote alarm.

It is another object of this invention to provide a reusable waste issue alarm device for the diaper to allow a guardian to monitor more than one diaper.

It is another object of this invention to provide a reusable waste issue alarm device for the diaper to issue an emergency alarm when the carried component of the device is submerged in water.

It is another object of this invention to provide a reusable waste issue alarm device for the diaper, wherein said reusable waste issue alarm device is equipped with adjustable belt unit with hanger to hold the device and hang it outside the diaper.

### BRIEF DESCRIPTION OF THE DRAWINGS

The objects and others will become more apparent with reference to the appended drawings, where in:

FIG. 1 is the block diagram of carried component of waste issue alarm device.

FIG. 2 is the block diagram of remote component of waste issue alarm device, indicating a remote alarm generator working with the alarm generator.

### DESCRIPTION OF THE PREFERRED EMBODIMENT

The waste issue alarm device consists of the carried component and the remote component.

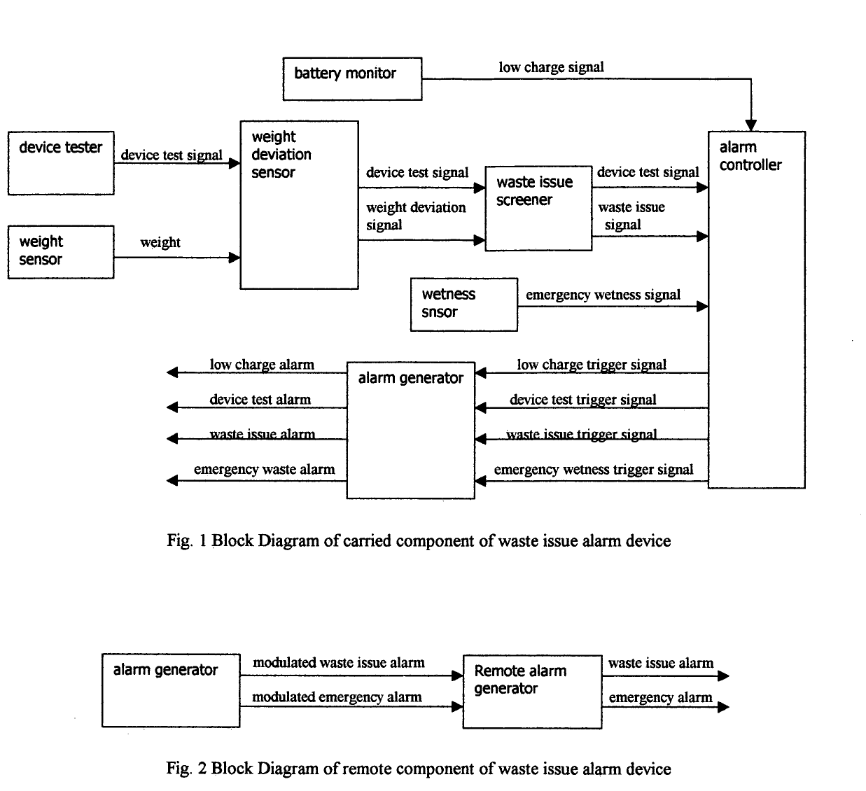

Referring to FIG. 1, said carried component of the invention, this invention provides a waste issue alarm device (device hereafter) for diaper. Said device is composed of a battery (not shown), a battery monitor, a device tester, a weight sensor, a weight deviation sensor, a waste issue screener, a wetness sensor, an alarm controller, and an alarm generator.

Said battery supplies the electric power to said device. Said battery monitor, consisting of a battery voltage or charge circuit, is responsible for monitoring the usefulness of said battery. A low charge signal may be sent from said battery monitor to said alarm controller. Upon receiving said low charge signal, said alarm controller will send low charge trigger signal to said alarm generator. The guardian will then change said battery, to supply enough electric power to said device. An indicator (not shown), ex. LCD, in said battery monitor, may indicate the low charge of said battery.

Said device tester is responsible for testing said device. When the user of said device, usually the guardian of the wearer, the baby sitter or nurse (guardian hereafter), performs the test of said device, said device tester will send a device test signal to said alarm generator through said weight deviation sensor, said waste issue screener, and said alarm controller. If the electric charge in the battery is good enough and said device is functional, said alarm generator will issue an audible and/or visible device test signal to indicate the usability of said device. If said battery is dead or said device is not functional, said alarm generator will issue no audible and/or visible device test signal. Therefore, the guardian will recognize the time to replace the battery or even said device. Said device tester may simply be a normal open switch connecting two conductive leads electrically isolated from each other. Closing said switch will electrically connect two said conductive leads and drop the electric resistance between them. And the drop of the electric resistance will become said device test signal.

The normal functionality is performed by said weight sensor, weight deviation sensor, said waste Issue screener, said alarm controller, and said alarm generator.

When the wearer of the diaper issues the urine or the feces, the weight inside the diaper will increase, and said weight sensor will send its weight to said weight deviation sensor. Said weight deviation sensor will detect the increment of the weight. Said weight deviation sensor shall start Its timer (not shown) and send a weight deviation signal indicating the deviation of the weight inside the diaper to said waste issue screener. Said weight deviation sensor shall repeatedly, at each preset period of time (say 0.1 second), detect the increment of the weight and send weight deviation signal to said waste issue screener, until time out (say 10 second) of said timer. Repeatedly receiving said weight deviation signal, said waste issue screener shall use its screen algorithm to screen out the false weight deviation signal, and recognize the right weight deviation signal. Said screen algorithm also discerns the urine issue from the feces issue.

Said screen algorithm is one of most important ideas of this invention. For explanation only, basically it checks at each period of time if said weight deviation signal indicating the weight inside the diaper is increased or unchanged. If it is decreased then said waste issue screener will ignore said weight deviation signal. Or if the increment is too big (say greater than one pound), said waste issue screener will also ignore said weight deviation signal. For it may be due to the wearers moving or posture changing. If the fragment of ounce increment occurs some period of time and then stop, said waste issue screener will recognize new urine issue. If the increment is ounces but it does not occur often, said waste issue screener will recognize new feces issue. In the cases that new feces issue comes with new urine issue, both of counts are recognized, or only new feces issue is recognized.

Once said waste issue screener recognizes the urine issue or the feces issue, it will increase the urine issue count or the feces issue count respectively. And said waste issue screener shall send a waste issue signal, consisting of the category of the waste (urine or feces) issue and its count, to said alarm controller.

Upon receiving said waste issue signal, said alarm controller will determine the way to send waste issue trigger signal to said alarm generator.

Different types of waste issue trigger signals may reflect the different waste issues, such as urine or feces. Said waste issue trigger signal for the feces issue type may be more obvious than that of the urine issue. Different numbers of waste issue trigger signals may also reflect the different waste issue counts. More number of waste issue trigger signals may be sent for more numerous waste counts. For instance, one waste issue trigger signal may be sent for one waste count. And two waste issue trigger signals for two waste counts, etc. Different lengths of waste issue trigger signals may also reflect the different waste counts. Longer waste issue trigger signals may be for more waste count. Different frequencies of waste issue trigger signals may also reflect the different waste counts. Waste issue trigger signals with higher frequency may be sent for higher waste counts.

By the same token, said waste issue screener may also calculate the weights of the waste issues, and different waste issue trigger signals may also reflect the weights of the urine issue and the feces issue.

Said alarm generator issues said waste issue alarm to guardian who follows strictly and faithfully to the received said waste issue trigger signal. The guardian then figures out the number of times for urine issue or feces issue by different waste issue alarm, and decides the need to change the diaper for the wearer. Said waste issue trigger signal may be sent periodically rather than continually. During each period there may be a number of said waste issue trigger signals following a quiet time. This will save the energy of battery. The period may be the same with waste counts. For instance, if the period is one minute, said waste issue trigger signal is only sent one time for each minute. The period may also reflect said waste count. Short period may be for high waste count. There may be a limit for the number of periods to send said waste issue trigger signal. For instance, the limit may be set as three, and there will be only three periods of time for said device to issue said waste issue alarm. This way the guardian will only be notified three times for each new waste issue. The limit for the number of periods may also reflect said waste count. Larger limit number may be issued for higher said waste count. There may be a display equipped on said alarm controller or alarm generator to indicate the urine issue count and the feces issue count. Thus said guardian may look at the display to find out the urine issue count and the feces issue count. Said waste count may be reset to zero once the guardian perform test against said device.

Referring to FIG. 2, said remote component of the invention, a remote alarm generator may be used to receive said waste issue alarm. In this case, said waste issue alarm may be modulated with a radio carrier. The modulated waste issue alarm will be sent through air to said remote alarm generator. A demodulator will be equipped in said remote alarm generator to demodulate said modulated waste issue alarm and issue audible and/or visible waste issue alarm to the guardian. Said remote alarm generator is usually located at a place remote to the wearer but near to said guardian. Thus, said guardian may notice the audible and/or visible waste issue alarm. Also, a power supply should be equipped for said remote alarm generator.

There may be an identification assigned to each said carried component, and said identification shall be included in said waste issue alarm and sent to said remote alarm generator. Said remote alarm generator shall indicate said identification, as well as the category of the wastes and their counts. That way, said guardian in different room may figure out which wearer of the diaper has issued the urine or the feces. This is especially useful for a nurse in a hospital taking care of more than one patient wearing a diaper.

Said remote alarm generator is also used for saving the wearer of the diaper from drowning. Said wetness sensor is for this function. It is virtually hidden in said device, it will not be reached by the urine sprinkling nor is it idle, until said carried component of said device is submerged in the water. When the wearer falls into the pool, said wetness sensor will detect the wetness and send an emergency wetness signal to said alarm controller. Upon receiving said emergency wetness signal, said alarm controller will send an emergency alarm trigger signal to said alarm generator and cause it to send a modulated emergency wetness alarm to said remote alarm generator. Upon receiving said modulated emergency wetness alarm, said remote alarm generator will issue an emergency alarm to warn the guardian to save the wearer from drowning.

An adjustable belt unit with hanger is used to hold said carried component of said device and hang it outside the diaper. The length of the belt is adjustable, thus said carried component of said device can be used for the diaper with different sizes. And the position of it on the belt is adjustable, thus it can be placed on the different position close to the bottom of the diaper. That way, no matter what the wearer's posture is (such as lying down, sitting, or standing), said device can detect the urine issue and the feces issue.

I claim:

1. A reusable waste issue alarm device apparatus for the diaper to detect the urine issue and the feces issue inside the diaper, and to issue the waste issue alarm consisting of the urine issue with its count and the feces issue with its count, and comprise an adjustable belt unit, a battery, battery monitoring means, device testing means, weight sensing means, weight deviation sensing means, waste issue screening means, alarm controlling means, alarm generating means, and wet sensing means, wherein:
a. said adjustable belt unit is to hold said waste issue alarm device and hang it outside the diaper, adjusting the length of the belt will allow said waste issue alarm device to be used for diapers with different sizes, and adjusting the position of said waste issue alarm device on the belt will allow said waste issue alarm device to detect the urine issue and the feces issue, no matter what the wearer's posture is;
b. said battery is to supply the electric power for said waste issue alarm device;
c. said battery monitoring means is to monitor the usefulness of said battery, and to indicate the lack of electric charge in said battery;
d. said device testing means is to test the functioning of said waste issue alarm device, and to reset said urine issue count and said feces issue count;
e. said weight sensing means is to measure the weight from said urine issue and said feces issue;
f. said weight deviation sensing means is to detect the weight increment due to new urine issue or new feces issue, and periodically notify the weight deviation to said waste issue screening means;
g. said waste issue screening means is to discern the urine issue from the feces issue and their counts, also to screen out the false weight deviations, which are neither from the urine issue nor the feces issue;
h. alarm controlling means is to send an alarm trigger signal reflecting the urine issue count and the feces issue count, and send alarm trigger signal to said alarm generating means;
i. said alarm generating means is to generate an audible and/or visible waste issue alarm, when the wearer issues urine or feces;
j. said wet sensing means, consisting of wetness sensor leads, to detect the amount of electric resistance between them, when said waste issue alarm device is submerged in the water, and cause it to issue an emergency alarm to human;

2. A reusable waste issue alarm device apparatus for the diaper to detect the urine issue and the feces issue in the diaper, and to issue the waste issue alarm to remote alarm device indicating the urine issue with its count and the feces issue with its count, and comprised of carried component and remote component, wherein said carried component consists of adjustable belt unit, a battery, battery monitoring means, device testing means, weight sensing means, weight deviation sensing means, waste issue screening means, alarm controlling means, alarm generating means, wet sensing means, and wherein said remote component consists of alarm generating means and remote alarm generating means, wherein:
a. said adjustable belt unit with hanger is to hold said waste issue alarm device and hang it outside the diaper, adjusting the length of the belt will allow said waste issue alarm device be used for diapers with different sizes, and adjusting the position of said waste issue alarm device on the belt will allow said waste issue alarm device to detect the urine issue and the feces issue, no matter what the wearer's posture is;
b. said battery is to supply the electric power for said waste issue alarm device;
c. said battery monitoring means is to monitor the usefulness of said battery, and to indicate the lack of electric charge in said battery;
d. said device testing means is to test the functioning of said waste issue alarm device, and to reset said urine issue count and said feces issue count;
e. said weight sensing means is to measure the weight from said urine issue count and said feces issue.
f. said weight deviation sensing means is to detect the weight increment due to new urine issue or new feces issue, and periodically notify the weight deviation to said waste issue screening means;
g. said waste issue screening means is to discern the urine issue from the feces issue and their counts, also to screen out the false weight deviations, which are neither from the urine issue nor the feces issue;
h. alarm controlling means is to send a alarm trigger signal reflecting the urine issue count and the feces issue count, and send alarm trigger signal to said alarm generating means;
i. said alarm generating means is to generate an audible and/or visible waste issue alarm, and to modulate said waste issue alarm and emergency alarm then send them to said remote alarm generating means by air, when the wearer issues urine or feces or said west issue alarm device is submerged in the water;
j. said wet sensing means, consisting of wetness sensor leads, to detect the amount of electric resistance between them, when said waste issue alarm device is submerged in the water, and cause it to issue an emergency alarm to remote alarm generating means;

3. depending on claim 2, an identification being assigned to each said carried component thus said remote alarm generation means can display said identifications and their urine issue counts;

4. depending on claim 1, a time limit of alarm being issued to notify the guardian for the waste issues;

5. depending on claim 2, a time limit of alarm being issued to notify the guardian for the waste issues;

6. depending on claim 1, said waste issue alarm being reflected to the category of the wastes, their counts and weights;

7. depending on claim 2, said waste issue alarm is being reflected to the category of the wastes their counts and weights.
